(19) United States
(12) Patent Application Publication
(10) Pub. No.: US 2023/0160499 A1
(43) Pub. Date: May 25, 2023

(54) HOLDER ELEMENT FOR FLEXIBLE LINES

(71) Applicant: Miele & Cie. KG, Guetersloh (DE)

(72) Inventors: Johannes OTTENSMEIER, Buende (DE); Frank SCHOENING, Rheda-Wiedenbrück (DE)

(21) Appl. No.: 17/997,661

(22) PCT Filed: Apr. 27, 2021
(86) PCT No.: PCT/EP2021/060900

§ 371 Date: Nov. 1, 2022

(30) Foreign Application Priority Data
May 14, 2020 (DE) 10 2020 113 042.2

(51) Int. Cl. F16L 3/04; H05B 6/12; H02G 3/32

(52) U.S. Cl. CPC F16L 3/04; H05B 6/1209; H02G 3/32; H05B 2206/022

(57) ABSTRACT

A holder element for flexible lines to be held on a base and to hold at least one flexible line includes: a bracket portion having an open side for receiving the at least one flexible line; and a clamping element which is arranged inside the open side of the bracket portion and presses the received at least one flexible line away from the bracket portion onto the base.

### CROSS-REFERENCE TO PRIOR APPLICATIONS

This application is a U.S. National Phase application under 35 U.S.C. § 371 of International Application No. PCT/EP2021/060900, filed on Apr. 27, 2021, and claims benefit to German Patent Application No. DE 10 2020 113 042.2, filed on May 14, 2020. The International Application was published in German on Nov. 18, 2021 as WO 2021/228542 under PCT Article 21(2).

### FIELD

The invention relates to a holder element for flexible lines, and to a device, preferably a domestic appliance, particularly preferably an induction hob, having at least one such holder element.

### BACKGROUND

In many technical fields it is necessary to use flexible lines, for example electrical lines, data lines and/or media lines, for example, tubes between different components of a product or also between different products, in order to transport electrical energy, electrical signals, light or light signals, as well as media such as fluids in the form of liquids and/or gases, and the like. Such electrical lines usually comprise an electrically conductive core, for example in the form of a copper strand having at least one electrically insulating sheathing typically made of plastics material, in their longitudinal extension direction. Similarly, optical waveguides comprise, in their longitudinal extension direction, a light-conducting core usually made of glass having a light-impermeable sheathing usually made of plastics material. Media lines such as tubes, for example, usually comprise a through-opening for the medium in their longitudinal extension direction, which is usually enclosed by a flexible material such as plastics material, for example, as a casing. In any case, flexible materials are usually used, in particular for the sheathing or the casing, such that the lines, which are flexible with respect to their material, can be bent during laying and can thereby be laid and arranged flexibly, i.e. adaptably.

For example, in electronic appliances such as in induction hobs, for example such data lines are used for information transmission, in order to connect different components of the induction hob, such as a control unit to sensors, display elements and/or operating elements, in a signal-transmitting manner. For example, this can be carried out comparatively easily and/or cost-effectively using a LIN bus (Local Interconnect Network) as a serial communication system.

The disadvantage in the case of electrical signal transmission in an induction hob is that the data line can be exposed to interference signals which can be generated for example by the induction coils, during operation. This can apply in particular when using a LIN bus in an induction hob, since the data line of the LIN bus usually comprises just one single sheathed strand, which can accordingly be prone to interference from the interference signals of the induction coils.

In order to shield the data line and in particular the LIN bus from such interference signal in induction hobs, it is known to lay the data line as close as possible to metal flat components of the induction hob, such as a retaining plate below the induction coils, which retaining plate, for example as an aluminum sheet, can usually bring about effective shielding. As a result, the quality of the signal transmission via the data line by means of electrical signals can be improved, and malfunctions of the induction hob during operation can be avoided, without additional effort being required for this purpose.

The problem here is that the data line must be fastened or fixed as directly as possible to the retaining plate over its entire length, in order to have the required proximity to the retaining plate so that the metal material of the retaining plate can have a shielding effect and can keep the interference signals of the induction coils sufficiently far from the data line.

Until now, such data lines of the LIN bus in induction hobs have been mounted and held on the retaining plate by means of cable holders. Such cable holders are usually designed to be closed or closable perpendicularly to the longitudinal extension direction of the flexible line to be held, such that some of the cable holder is arranged between the data line and the retaining plate.

A disadvantage here is that the longitudinal course of the data line is spaced apart from the retaining plate by the cable holder, which can lead to a corresponding reduction of the shielding effect of the retaining plate.

It is also disadvantageous that such cable holders can hold the data line only at points but cannot fasten it to the retaining plate. Thus, the data line can move significantly, relative to the retaining plate, along its longitudinal extension. If the data line is mounted in a suspended manner using cable holders arranged at points, the data line can thus hang down between the cable holders and thus possibly be significantly spaced apart from the retaining plate, which can correspondingly reduce, and may even completely eliminate, the shielding effect of the retaining plate.

A further disadvantage is that the data line can only be received and held loosely by such cable holders. A tensioned course of the data line along its longitudinal extension direction, as a result of which the mobility of the data line could be reduced, at least in part, is therefore not possible by means of such cable holders.

In order to be able to fasten or fix the data line, between the cable holders arranged at points, close to the retaining plate and in a defined manner, adhesive tapes or adhesive strips can additionally be used. As a result, the data line between the cable holders arranged at points can likewise be adhesively bonded directly to the retaining plate in portions or also over its entire length between two cable holders. This can in part or completely prevent the mobility of the data line and ensure a defined course of the data line and a direct proximity of the data line to the retaining plate. The data line can also be arranged tensioned on the retaining plate and then fastened or fixed on the retaining plate by means of adhesive tape or adhesive strips, in this position.

However, it is disadvantageous in this case that the use of adhesive tape or adhesive strips can mean not inconsiderable manual effort during the assembly of the induction hob. The additional use of adhesive tape or adhesive strips can also lead to additional material costs for the assembly.

It is also disadvantageous that different employees may use adhesive tape or adhesive strips differently, in order to adhesively bond the data line to the same retaining plate. This can also apply to the same employee in the case of a plurality of identical retaining plates. As a result, it cannot be ensured that the data line is fastened or fixed to the respective retaining plate in such a way that the shielding effect of the retaining plate can be ensured, in particular equally, for every induction hob to be assembled.

It is further disadvantageous that the manual handling of adhesive tape or adhesive strips by the employee during assembly can lead to soiling of the adhesive surface. This can reduce the fastening or fixing adhesive effect of the adhesive tape or adhesive strip and eliminate the fastening or fixing already during assembly or also only after some time. The adhesive effect of adhesive tape or adhesive strips can also fail permanently for other reasons. In particular, the adhesive of the adhesive tape or adhesive strip may be sensitive to moisture and/or temperature and thereby lose adhesive effect. This can in any case result in the shielding effect of the retaining plate on the data line being reduced or eliminated only during use by the customer, and then malfunctions in the operation of the induction hob can occur, which result in a restriction and/or interruption of the use of the product by the customer, and can make repair by aftersales services necessary.

In other words, it has hitherto only been possible to hold a flexible line, such as the data line of a LIN bus, in the case of products such as in an induction hob, on a component, such as on the retaining plate, at points, but not to fasten or fix the flexible line directly on a base of a component, for example on the retaining plate. If adhesive aids are used for this purpose, this can lead to the disadvantages described above. This applies in each case to different types of flexible lines, for example electrical lines, data lines and/or media lines such as tubes.

### SUMMARY

In an embodiment, the present invention provides a holder element for flexible lines to be held on a base and to hold at least one flexible line, comprising: a bracket portion having an open side configured to receive the at least one flexible line; and a clamping element which is arranged inside the open side of the bracket portion and is configured to press the received at least one flexible line away from the bracket portion onto the base.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a perspective view of a holder element according to the invention for flexible lines; and

FIG. 2 is a side view of FIG. 1.

### DETAILED DESCRIPTION

In an embodiment, the present invention provides a holder element for flexible lines of the type described at the outset, which enables the flexible line to be fastened as directly as possible to a device. This is made possible in particular for a plurality of flexible lines together. This is achieved in a manner that is as simple, quick, cost-effective, durable, uniform and/or process-reliable. At least one alternative to known holder elements of this kind may be provided.

The present invention therefore relates to a holder element for flexible lines, which element is designed to be held on a base and to hold at least one flexible line. In other words, the holder element itself can be connected to the base and arranged there. Furthermore, at least one flexible line, for example an electrical line, a data line and/or a media line, such as a tube having flexible material properties, can be held by the holder element, such that the flexible line can be held and arranged on the base by means of the holder element. The base can be the surface of a device. In particular, this can be the surface of a retaining plate of an induction hob as a device, as described at the outset.

As described at the outset, known holder elements hitherto hold flexible lines loosely, such that although the flexible line can be arranged and held on the base by means of the known holder elements, it cannot, however, be fastened or fixed there. In other words, flexible lines of this kind can be held by means of known holder elements only in such a way that they are flexibly movable, at least in part, along their longitudinal extension direction, even in the held state, and can assume a spacing, in particular with respect to the base, in particular in the case of a suspended arrangement. A stretched or tensioned course of flexible lines in the held state, along the longitudinal extension direction thereof, likewise cannot be achieved by such known holder elements.

The holder element according to the invention for flexible lines is characterized by a bracket portion having an open side for receiving the flexible line, and by a clamping element which is arranged inside the open side of the bracket portion and is designed to press the received flexible line away from the bracket portion, preferably resiliently, onto the base.

In other words, the holder element according to the invention is designed to be open towards the base and can receive the at least one flexible line, or possibly also a plurality of flexible lines together, between it and the base. This can increase the proximity of the received flexible line to the base or reduce the spacing, which can prove advantageous for example for a shielding effect of a retaining plate as a base in an induction hob, as described at the outset.

Furthermore, the received flexible line can be additionally pressed, inside the bracket portion, by the clamping element, towards the base, which can yet further increase the proximity of the received flexible line to the base or further reduce the spacing. In addition, clamping of the received flexible line between the holder element and the base can thereby be achieved, such that the received flexible line not only can be held on the base by the holder element, as previously known, but can be fastened or fixed to the base. In the held state of the received flexible line, this can enable a defined and in particular a tensioned course along its longitudinal extension direction, as a result of which a greater proximity of the received flexible line to the base or a smaller spacing therebetween can be achieved than hitherto known, in particular over the longitudinal extension direction. This can also be advantageous for example for a shielding effect of a retaining plate as a base in an induction hob, as described at the outset. In particular, the use of adhesive tape or adhesive strips in order to achieve such fastening or fixing can be dispensed with.

According to one aspect of the invention, the bracket portion comprises at least two contact surfaces which are designed to rest on the base, the clamping element comprising a clamping portion which extends at least substantially in parallel with the contact surfaces and is designed to press the received flexible line away from the bracket portion, preferably resiliently, onto the base. As a result of the contact surfaces, a defined and stable, in particular flat, contact of the bracket portion of the holder element with the base can be achieved. The clamping portion of the clamping element can enable the pressing, described above, of the received flexible line. The arrangement or the orientation of the clamping portion of the clamping element extending in parallel with the contact surfaces can favor the proximity of the clamping portion of the clamping element to the base, and as a result the, preferably resilient, pressing effect of the clamping portion of the clamping element on the received flexible line.

According to a further aspect of the invention, the clamping element comprises a support portion which extends at least substantially perpendicularly to the clamping portion and is designed to support the clamping portion relative to the bracket portion. This can enable a force transmission from the clamping portion to the bracket portion, such that the clamping portion of the clamping element can exert its pressing function, as described above, in particular resiliently in relation to the bracket portion.

According to a further aspect of the invention, the clamping element comprises a joint portion which resiliently interconnects the clamping portion and the support portion, preferably at least substantially at right angles. This can enable a resilient force transmission between the clamping portion and the support portion of the clamping element.

According to a further aspect of the invention, the bracket portion is U-shaped. This can enable the formation of a bracket portion having an open side, which can in particular be implemented in a structurally simple and/or structurally compact manner.

According to a further aspect of the invention, the bracket portion comprises at least one joint portion which is designed to resiliently absorb compressive forces from the clamping element. This can facilitate the exertion of pressing forces of the bracket portion and/or of the clamping element on at least one received flexible line.

According to a further aspect of the invention, the joint portion of the bracket portion is arranged in a corner of the bracket portion. This can simplify the implementation and/or promote the resilient effect of the joint portion.

According to a further aspect of the invention, the joint portion of the bracket portion is designed as a material weakening of the bracket portion. This can simplify the implementation of the joint portion, in particular as an integral injection-molded part.

According to a further aspect of the invention, the support portion of the clamping element is arranged on the joint portion of the bracket portion. This can facilitate the, in particular resilient, transmission of forces from the support portion of the clamping element to the bracket portion.

According to a further aspect of the invention, the holder element comprises two flank portions which are each arranged on an open end of the bracket portion and each comprise one of the two contact surfaces, facing away from the bracket portion, the clamping portion of the clamping element extending between the two flank portions. This can simplify the arrangement or design of the contact surfaces. The proximity of the clamping portion of the clamping element to the base, and as a result the, preferably resilient, pressing effect of the clamping portion of the clamping element on the received flexible line, can also be facilitated by the course of the clamping portion of the clamping element between the two flank portions of the holder element.

According to a further aspect of the invention, the two contact surfaces each comprise at least one connecting element which is designed to connect the holder element to the base. This can enable simple and effective mounting of the holder element on the base. In particular, this makes it possible to dispense with additional connecting means which could result in additional costs with regard to material and/or assembly complexity.

According to a further aspect of the invention, at least one connecting element, preferably both connecting elements, are designed as a latching element to be resiliently inserted into a corresponding recess or through-opening of the base and to be held in the recess or through-opening of the base in a manner engaged behind. This can be a particularly simple, low-cost and/or effective way of connecting the holder element and the base.

According to a further aspect of the invention, the bracket portion and the clamping element are formed integrally, preferably as an injection-molded part. In other words, the holder element is produced in one piece together with the bracket portion and clamping element, which can simplify, accelerate and/or make more cost-effective the production, in particular as an injection-molded part.

The present invention also relates to a device, preferably a domestic appliance, particularly preferably an induction hob, having at least one flexible line, which is fastened by means of at least one holder element as described above, preferably by means of a plurality of holder elements as described above, on a base, preferably on a retaining plate. In this way, the previously described properties and/or advantages of holder elements according to the invention can be implemented and used in a device, preferably in a domestic appliance, particularly preferably in an induction hob.

In other words, two functions can be realized equally by means of a holder element according to the invention for flexible lines having an integrated film hinge. The first function is the function of locally fixing a flexible line or a plurality of flexible lines. This can take place by means of a bracket portion of the holder element which can hold the flexible line at the desired position. The second function of the proximity of the flexible line to the base, for example as a retaining plate, can be realized by means of a flexible bracket as a clamping element, which can press or clamp the flexible line directly onto the retaining plate, as a base, located underneath. This clamping mechanism can enable on the one hand the plate proximity and on the other hand a “tensioning” of the flexible line along its longitudinal extension. Thus, the cable length between a connection or between two holder elements according to the invention can be drawn tautly and thus fastened or fixed flat to the holding plate.

The uniform use of such holder elements according to the invention as cable holders, for example in all induction hobs of a manufacturer, can enable the greatest possible implementation and use of the properties and advantages of the present invention. As a result, the previously known and used cable holders described at the outset can be replaced. This can also increase the quality of the products or devices in which at least one holder element according to the invention is used. Furthermore, a cost reduction can be achieved by the uniform use of holder elements according to the invention.

In particular, the use of at least one holder element according to the invention in a product or in a device can enable or ensure a uniform, defined and/or secure laying of the flexible line. For this purpose, the positions at which the holder elements according to the invention are to be arranged can be predetermined in a fixed and defined manner on the base in the product or device by the formation of recesses or through-openings. This can enable or ensure a consistent execution and quality of the assembly of the holder elements according to the invention, as well as of the flexible line, in the case of the same employee and also in the case of different employees for the assembly. In particular, the individual use of adhesive tapes or adhesive strips can be dispensed with or these can be avoided.

The improvement and/or the assurance of the shielding, described at the outset, by means of the retaining plate in induction hobs can reduce, and possibly even minimize, the likelihood of faults occurring at the customer, which are attributable to interference signals of the induction coils on the LIN bus.

The above figures are viewed using Cartesian coordinates. A longitudinal direction X extends, which can also be referred to as depth X or as length X. A transverse direction Y, which can also be referred to as width Y, extends perpendicularly to the longitudinal direction X. A vertical direction Z, which can also be referred to as height Z, extends perpendicularly both to the longitudinal direction X and to the transverse direction Y.

A holder element 1 according to the invention is designed integrally as an injection-molded part and can also be referred to as a cable holder 1. The holder element 1 consists essentially of a U-shaped bracket portion 10, on the two open ends of which two flank portions 11 of the holder element 1 project outwards perpendicularly in the width Y, at right angles to the bracket portion 10. The two flank portions 11 each comprise a contact surface 12 facing away from the bracket portion 10 in the height Z. A connecting element 13 in the form of a latching element 13 is formed integrally on each contact surface 12, pointing away from the contact surface 12 in the height Z.

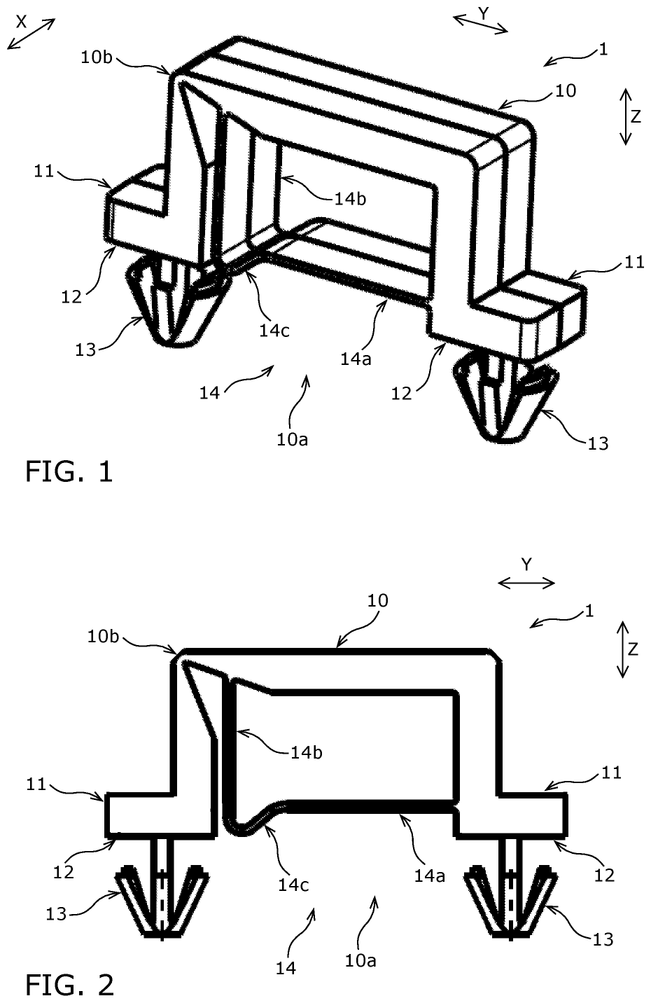

The U-shaped bracket portion 10 comprises an open side 10a which, in the illustration of FIGS. 1 and 2, points downwards in the height Z, and in the width Y is arranged in particular between the two flank portions 11 of the holder element 1. A clamping element 14 is formed integrally with the bracket portion 10, within the open side 10a of the bracket portion 10, said clamping element comprising a clamping portion 14a extending in a straight line, in the width Y, from the one flank portion 11 of the holder element 1, on the right-hand side in the illustration of FIGS. 1 and 2. At its left-hand end, the clamping portion 14a of the clamping element 14 merges into a supporting portion 14b of the clamping element 14, via a joint portion 14c of the clamping element 14 which is bent downwards in the height Z. The supporting portion 14b of the clamping element 14 merges into the bracket portion 10, in the height Z, close to the left-hand top corner of said bracket portion. The left-hand top corner of the bracket portion 10 in turn comprises a joint portion 10b in the form of a material weakening 10b.

The holder element 1 according to the invention can be received and held by its latching elements 13 in corresponding recesses or through-openings of a base. In this case, at least one flexible line can be received by the clamping portion 14a of the clamping element 14, between this and the base, pressed against the base, and thus not only held loosely by the holder element 1 but can be fastened or fixed in a clamping manner directly on the base by the holder element 1 or by its clamping portion 14a of the clamping element 14. The required resilient compressive forces can be applied or absorbed both by the resilient joint portion 14c of the clamping element 14 and by the resilient joint portion 10b of the bracket portion 10.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

X longitudinal direction; depth; length
Y transverse direction; width
Z vertical direction; height
1 holder element for flexible lines; cable holder
10 bracket portion
10a open side of the bracket portion 10
10b joint portion or material weakening of the bracket portion 10
11 flank portions
12 contact surfaces
13 connecting elements; latching elements
14 clamping element
14a clamping portion of the clamping element 14
14b support portion of the clamping element 14
14c joint portion of the clamping element 14

1: A holder element for flexible lines
to be held on a base and to hold at least one flexible line, comprising:
a bracket portion having an open side configured to receive the at least one flexible line; and
a clamping element which is arranged inside the open side of the bracket portion and is configured to press the received at least one flexible line away from the bracket portion onto the base.

2: The holder element of claim 1, wherein
the bracket portion comprises at least two contact surfaces which are configured to rest on the base, and
wherein the clamping element comprises a clamping portion which extends at least substantially in parallel with the contact surfaces and is configured to press the received flexible line away from the bracket portion onto the base.

3: The holder element of claim 2, wherein
the clamping element comprises a support portion which extends at least substantially perpendicularly to the clamping portion and is configured to support the clamping portion relative to the bracket portion.

4: The holder element of claim 3, wherein
the clamping element comprises a joint portion which resiliency interconnects the clamping portion and the support portion.

5: The holder element of claim 1, wherein
the bracket portion is U-shaped.

6: The holder element of claim 3, wherein
the bracket portion comprises at least one joint portion which is configured to resiliently absorb compressive forces from the clamping element.

7: The holder element of claim 6, wherein
the joint portion of the bracket portion is arranged in a corner of the bracket portion.

8: The holder element of claim 6, wherein
the joint portion of the bracket portion comprises a material weakening of the bracket portion.

9: The holder element of wherein
the support portion of the clamping element is arranged on the joint portion of the bracket portion.

10: The holder element of claim 2, further comprising:
two flank portions which are each arranged at an open end of the bracket portion and comprise one of the two contact surfaces, facing away from the bracket portion in each case,
wherein the clamping portion of the clamping element extends between the two flank portions.

11: The holder element of claim 2, wherein
the two contact surfaces each comprise at least one connecting element which is configured to connect the holder element to the base.

12: The holder element of claim 11, wherein
at least one connecting element is configured as a latching element to be resiliently inserted into a corresponding recess or through-opening of the base and to be held in the recess or through-opening of the base, in a manner engaging behind.

13: The holder element of claim 1, wherein
the bracket portion and the clamping element are formed integrally.

14: A device, comprising:
at least one flexible line which is fastened to a base by at least one holder element according to claim 1.

15: The holder element according to claim 1, wherein the clamping element is configured to press the received at least one flexible line away from the bracket portion resiliently onto the base.

16: The holder element according to claim 2, wherein the clamping element is configured to press the received flexible line away from the bracket portion resiliently onto the base.

17: The holder element of claim 4, wherein joint portion resiliently interconnects the clamping portion and the support portion at least substantially at right angles.

18: The holder element of claim 12, wherein both connecting elements are configured as latching elements, each to be resiliently inserted into a corresponding recess or through-opening of the base and to be held in the recess or through-opening of the base, in a manner engaging behind.

19: The holder element of claim 13, wherein the bracket portion and the clamping element are formed integrally as an injection-molded part.

20: The device of claim 14, wherein the device comprises a domestic appliance.
